(19) United States
(12) Patent Application Publication
(10) Pub. No.: US 2012/0076633 A1
(43) Pub. Date: Mar. 29, 2012

(54) APPARATUS AND METHOD FOR THE SEPARATING AND TRANSPORTING OF SUBSTRATES

(75) Inventors: Siegfried Renn, Rottweil (DE); Roland Dechant-Wagner, Villingen-Schwenningen (DE)

(73) Assignee: RENA GMBH, Gutenbach (DE)

(21) Appl. No.: 13/209,340

(22) Filed: Aug. 12, 2011

(30) Foreign Application Priority Data
Sep. 13, 2010 (DE) 102010045098.7

(51) Int. Cl. B65G 59/00; B65G 47/91

(52) U.S. Cl. 414/798.9; 414/801

(57) ABSTRACT

The invention relates to a separating, deflecting and transporting of a disc like substrate (3) such as e.g. a solar wafer. The apparatus (1) for the separating, deflecting and transporting of disc shaped substrates (3) which are sequentially arranged standing one after another in feed direction in the form of a substrate stack (5) within a liquid, comprises a vertical belt conveyor (9) with at least two conveyor belts (11, 11″), whose conveying span (10) is arranged at one front side (12) of the stack (5) parallel to the front side (12), wherein the belt conveyor (9) has a vacuum device (16) by means of which the respective foremost substrate (3) of the stack (5) can be sucked against at least a first conveyor belt (11), and wherein the at least two conveyor belts (11, 11″) of the vertical belt conveyor (9) are arranged coplanar to each other in the adjoining region.

This invention claims benefit of priority to German patent application serial no. 10 2010 045 098.7, filed Sep. 13, 2010.

The invention is a further development of the technology which is disclosed in document DE 10 2006 011 870 B4 and relates to an apparatus for the separating and transporting of disc-shaped as well as fragile substrates.

The invention further relates to a method for the separating and transporting of substrates that are being provided in a substrate stack.

The “substrates” are disc- or plate-shaped and usually rectangular. They are obtained from a substrate block subjected to a sawing process. They have continuous edges that are substantially straight, wherein the corners can be of a rectangular, a rounded, or chamfered shape.

A “substrate stack” defines by a plurality of substrates that are stacked onto each other or arranged side by side or one after the other. According to the invention, a stack in which the substrate surfaces are horizontal is referred to as a “laying” stack of substrates laying one onto the other; if the substrate surfaces are vertical, this corresponds to a “standing” stack of substrates standing side by side. The individual substrates are already detached from a holding means that is necessary for the sawing process, and stacked free and independent from each other. Unintentionally, however, the individual substrates often still adhere to their mutual surfaces due to the previous sawing process. For the further processing, it is usually necessary to separate these so stacked substrates. This means that the substrate that is provided at the end of an upright positioned substrate stack shall be removed with an apparatus from the substrate stack and transferred into the further treatment process.

The “stack direction” of the substrates within a substrate stack is determined by the position of the substrate to be separated. The individual substrates are oriented such that they are substantially standing with their surfaces being contiguous to one another. For the special case of exactly and entirely contiguously oriented substrate surfaces, the stack direction corresponds exactly to the direction of the surface normal of the substrate(s), wherein the positive direction points to that end of the stack from which the next substrate to be separated shall be taken. If this substrate is positioned at the right side of the “standing” substrate stack being arranged within the carrier device, the stack direction thus points to the right in arrow direction.

The “feed direction” as well as the “transport direction” of a stack substantially corresponds to the stack direction.

The “stack start” and the “front side of the stack” denote that end of the substrate stack, at which the next substrate to be separated is located. This is that end that points in feed direction. However, if it is generally referred to a “stack end”, this does not clarify whether the stack start or the opposite end of the stack is meant.

The substantially perpendicular or upright positioned substrate stacks are provided in a “carrier device” with one edge of each substrate being supported on the carrier device. The carrier device picks up the substrate stack for example after sawing and/or removing of the glue that is often used in order to fix the initially unsawed substrates onto a holding plate, and transports it to an unloading device where separation shall take place. The carrier device preferably is designed such that it takes up the substrate stack as a whole, i.e. the individual substrates substantially stand contiguously next to each other or one after the other, respectively.

In particular for the simplification of the transport of the carrier device which is filled with substrates, the same can advantageously be equipped with two brush strips which are arranged laterally and parallel to each other and which run in feed direction, by means of which the substrates can be held in position in the stack; optionally, until their respective removal. Therefore, the strips are connected with the carrier device by means of suitable hinge or slewing means in such a manner that the device can easily be loaded and the substrates can be securely held in position; if desired, until their respective removal. Because of the hinge- or slewability of the brush strips, their holding function can be used as required.

According to the invention, “adhesion” means forces that act between two surfaces and evolve from the approach of these two surfaces to one another. Since the adhesion forces described according to the invention shall develop within a fluid, it is necessary that the fluid volume located between the two surfaces is reduced, what, in general, can be achieved by displacement and/or through extraction by suction. In order to comply with the object of the invention of an as much as possible gentle handling of the substrates, the reduction of the volume is only carried out to the extent that a fluid- or liquid film remains between the surfaces.

The “unloading or separation device” serves for the removing or separating and transporting of a substrate away from the substrate stack. Here, the substrate that is located at the one end of the substrate stack is picked up by the unloading or separation device by means of suction devices, detached from the substrate stack and thus separated, and fed into a subsequent treatment or transport process. The unloading device serves for dislocating the substrate to be separated from the substrate stack, whereby the “unloading” or “separation”, respectively, is effected in a substantially vertical direction. In other words, the substrate to be separated is shifted or removed upwards, preferably approximately perpendicular to the plane of the carrier device, by shifting with respect to the subsequent substrate in direction of the planar extension of the substrate, so that advantageously, only shear forces develop between the two substrates.

Depending on the unloading direction, different forces of different magnitude act on the substrate to be separated and the substrates still located in the stack, whereby these forces particularly act on the substrate, following the substrate just being unloaded.

For separation of the substrate stack it is intended that the stack together with the carrier device is arranged within a fluid, whereby it has to be understood that this means substantially liquid media. Within the fluid, “flow devices” are provided that blow the fluid against the substrate stack from one or the side(s) and/or from below or above, respectively. This takes place in such a manner that a flow is achieved that is directed to the substrate stack and results in “fanning” of the individual substrates and keeping them in a distance to each other. This means that between the individual substrates an interspace develops which is filled with fluid, and which can fulfill the function of a fluid damping cushion.

According to a preferred embodiment, this fanning can be supported with additional suitable means, e.g. with ultrasonic transducers particularly positioned in the fanning region. This is particularly advantageous if the adhesion forces between the substrates touching each other are so strong that, otherwise, an entrance of the fluid does only take place very slowly.

WO 01/28745 A1 discloses methods and devices for the detachment of disc shaped substrates, wherein the separation takes place in the dry, i.e. outside of a liquid bath. A humidifying of the substrates can only occur by nozzles. A robot-like device grips the substrate to be detached via suction devices (active generation of a gas vacuum e.g. by a vacuum pump), whereby the substrate is detached from the holding means by an oscillating movement of the device. Oscillating movements in different directions are enabled. Gripping of the substrate to be separated takes place by aid of a suction device that is arranged above the surface of the substrate and fixed to the device. For release of the substrate, a certain gas over pressure is generated within the suction device so that the detached substrate can again be removed from the device.

DE 199 00 671 A1 discloses methods and devices for the detachment of disc shaped substrates such as, in particular, of wafers. It is proposed that the substrates that adhere to each other directly subsequent to the sawing process and that are still fixed with their one side (edge) to the holding devices are kept in a distance to each other by a well-directed fluid jet. A wedge device serves for the separation of the substrate to be detached from the holding device. At the same time, the separated substrate is removed from the holding device by a gripper arm like device having suction devices.

DE 697 22 071 T2 discloses an apparatus for the placing of wafers that have been obtained by sawing of a substrate block into a storage element. Handling devices are proposed that allow for gripping of round or square cross sectioned substrates and for transferring them into a stand like object. In doing so, several substrates are picked up simultaneously and transferred to a placement area that receives the separated substrates.

DE 199 04 834 A1 discloses an apparatus for the detachment of single thin, fragile and disc like substrates. The substrate block with the already sawed substrates is located within a tank filled with fluid. In contrast to the prior art, the holding device together with the substrates that are still fixed to the holding device is arranged vertically, so that the substrate to be separated is arranged parallel to the fluid surface. A wedge device causes the substrate to be separated being detached from the glass plate. A conveyor belt that is arranged in close proximity to the substrate serves for the transport of the detached and floating substrates. A pushing device ensures that the holding device is always brought in the same position and horizontally moved against the wedge device for the detachment of the respective substrate. On the other side of the conveyor belt a device is provided for the automatic insertion of the separated substrates into a stand. Aim of the detachment is that the separated, disc like substrates are stacked after being removed from the holding device and inserted in predetermined devices or placed directly and contiguously on top of each other.

EP 0 762 483 A1 also discloses an apparatus that is, inter alia, capable of separating planar substrates. The already separated substrates are provided in a carrier device, where they for the time being touch each other with their surfaces. For separation and transfer into a container the substrates are transported away from the stack using a pusher and, if desired, by the aid of rollers and/or fluid jets, wherein it is imperative that the substrates are in a horizontal, i.e. lying position. According to the previous clarification, the substrates are thus arranged in the form of a “lying” stack of substrates lying upon each other. Alternatively, the document discloses a separation by use of a suction gripper that must be supplied with a gas vacuum during the entire gripping- and transporting process, and that directly touches the substrate, i.e. with no protecting fluid film between gripper and substrate surface.

However, the as much as possible gentle separation of the respective substrates according to the art is difficult and suffers from a number of disadvantages.

If it is desired to omit manual operation, movements are necessary for the separation and require complex devices. However, since the substrates are very fragile and thin, plate like substrates, these cannot be picked up offhand with common gripper like systems. Hence, it is necessary to provide very precise and sensitive devices.

Accordingly, the previously mentioned state of the art substantially discloses such devices that grip the respective substrate by means of a suction device. Directly after the suction device has been moved toward the planar surface of the substrate to be separated, a gas vacuum is generated by a vacuum pump between suction device and substrate to be separated, so that an attachment of the substrate to a handling device is possible.

However, care must be taken since the substrate to be separated can break because of the low pressure being too high.

In contrast to these methods in which a vacuum or a low pressure of least 1 mbar has to be adjusted between two surfaces, the adhesion according to the invention upon maintenance of a fluid- or liquid film is effected by a low pressure that is much weaker than a vacuum and ranges between 0.3 and 0.5 bar, and preferably is approx. 0.4 bar.

In doing so, another critical point arises from the fact that the respective substrate must be approached, i.e. contacted by the handling device. Since the substrate may not in any case be pushed away by the device, an exact positioning is necessary. However, this is difficult, since on one hand, there is provided a relative movement of the holding device for positioning of the substrate to be separated in the region of the holding device, thus providing the holding device itself corresponding degrees of freedom. Therefore, tolerances are possible that result in a possible damage of the substrate to be separated. On the other hand, such movements usually take place within a fluid, so that the substrates run the risk of being dislocated or even broken by a flow pressure that results from the individual movements of the devices, especially towards the substrates.

A separation carried out manually involves the risk that the very thin and fragile as well as disc shaped substrates break, in particular because of the increased adhesion forces.

The separation device of DE 10 2006 011 870 B4, on which the present invention is based for improvement, has a basin with liquid in which the stack with the substrates to be separated is arranged, wherein the substrates of the stack are silicon plates which can be separated directly out of the liquid of the basin. Therein, the conveying span plunges with the start of its conveyor line into the liquid such that its conveying span stretches in a distance from the front side of the stack (stack end) in parallel to the front side of the stack (stack start). The separation takes place by sucking the substrates to a conveying belt of the belt conveyor, wherein the liquid which is present in the basin is sucked by means of the vacuum device of the belt conveyor, differing from the air which is used in common devices. The vacuum device is provided at the belt conveyor by means of which a foremost substrate of the stack is sucked together with the liquid which surrounds the substrate, until the substrate bears against the conveying belt and is fixed to the conveying belt by a negative pressure of the vacuum device.

The substrates which shall be separated by means of the apparatus can touch each other, or they can form the stack while being spaced apart from each other, wherein the substrates are always arranged parallel to each other and to a conveying span of the belt conveyor. The substrate which is fixed to the conveying belt is moved together with the conveying belt and transported in parallel to a front side of the stack away from the stack. The conveying belt can be driven continuously or paced, with a constant or a varying velocity. In the case of a paced drive, it is necessary to detect the position of the substrate and/or the conveyor belt by means of a sensor, which can e.g. be arranged in front of the conveying span as a pressure sensor of the vacuum device, or as an electric eye. In the case of a continuous drive, the belt conveyor can or must be stopped when the sensor does detect no substrate on the conveyor belt in pick up position. The belt conveyor starts again when a substrate is ready for pick up.

The belt conveyor can be designed as horizontal or vertical conveyor, or it can combine both conveying directions with each other. Depending on the inclination of the transport line it is necessary to press the substrate against the conveying belt with a force that acts onto the substrate in order to achieve a sufficient friction force between the substrate and the conveying belt. This can e.g. occur by sucking with a vacuum device, or by pressing with support belts or support rollers, which clamp the substrate between them and the conveying belt. Thus, it is possible to transfer the plate shaped object from a standing orientation within the stack into a lying orientation at the end of the transport line.

In a preferred embodiment, the belt conveyor is a vertical conveyor which takes over the plate shaped substrate to be separated from a standing orientation in the stack, separates it, and conveys it in the standing orientation away from the stack in a vertical direction, preferably vertically upwards. A conveying line of the belt conveyor can have several subsequently arranged conveying belts, wherein at least the first conveying belt which de-stacks has the vacuum device for suction of the substrates. It shall be not excluded that the conveying belt is formed by several individual conveying belts which are arranged next to each other and which operate together. If the conveying line has several conveying belts which are subsequently arranged, they can be commonly driven. Alternatively, conveying belts of the conveying line can have an individual drive. This enables a larger distance between the conveyed, plate shaped substrates by drawing them apart using different belt velocities, or by temporarily stopping a preceding conveying belt.

In a further advantageous embodiment, the conveying belt has a nonlinear course. This can be achieved by guiding the conveying belt along a curved path, or by angularly arranging several subsequently arranged conveying belts.

Advantageously, at least one conveying belt is paced, preferably the de-stacking conveying belt at the beginning of the transport line of the belt conveyor. This has the advantage that the de-stacking conveying belt does not scratch along an upper side of the substrate surface which faces the conveying span during sucking of the substrate and damages the surface, in particular, when the objects are fragile. The conveying belt of the separation device stands still as long as no substrate is sucked against the conveying belt. As soon as substrate bears against the conveying belt and adheres to the same, the sensor of the vacuum device of the belt conveyor releases the conveying belt, and the substrate is carried along by the conveying belt without relative motion to the conveying belt.

In a further advantageous embodiment of the separation device, at least one conveying belt, in particular the de-stacking conveying belt, has in at least one region a defined hole pattern for suction and fixation of the substrate to the conveying belt. The whole pattern can have one or several holes which must not be circular, and which can also be connected with each other. The defined hole pattern is preferably designed according to the substrate such that its holes can be completely covered by the substrate. The conveying belt can have several of such hole patterns along its circumference, with the hole patterns being preferably arranged in the same distance to each other. For reception of the substrate by the de-stacking conveying belt, the hole pattern of the conveying belt is positioned adjacent to the front side of the stack and then stopped, wherein the stack is moved by means of its drive towards the hole pattern, and the substrate is sucked while the conveying belt stands still. The vacuum device of the belt conveyor can be deactivated until the substrate is recognized by a sensor which controls the vacuum device. For release of the substrate from the conveying belt, the vacuum device of the belt conveyor does not operate in regions of the conveying line, so that the substrate can simply be put down or transferred.

In a preferred embodiment of DE 10 2006 011 870 B4, the belt conveyor has guiding elements for the orientation and/or deflection of the plate shaped object which act upon the object as soon as the same is not longer held by vacuum at the conveying belt. Depending on the design of the guiding elements, by means of the same, the object can be held in its position on the conveying belt, oriented on the conveying belt, or guided away from the conveying belt.

In a further, preferred embodiment of the separation device, separation means are arranged in the region of the conveying span which avoid the adhesion to the stack of the substrate which is respectively located most proximate to the span. The separating means can for example orientate and, if necessary, separate, a foremost substrate of the stack with respect to the substrate which is located behind the substrate. The separation of substrates which adhere in sub-areas can occur by touching or contactless operation. The separation can for example take place by means of a mechanical manipulator or by means of a fluid flow, which acts at least upon the both plate shaped substrates which are located most proximate to the conveying span.

Regarding the method which is disclosed in DE 10 2006 011 870 B4 for the piecewise provision of plate shaped substrates from a standing orientated stack by means of a belt conveyor with conveying belt(s), the conveying span of which being arranged at one front side of the stack in parallel to the front side, and with a drive for moving the stack in direction of the span, wherein the belt conveyor has a vacuum device by means of which a topmost substrate of the stack can be sucked against at least one first conveying belt, the separation takes place in the following steps:

(A) Providing a stack with plate shaped substrates in the form of silicon plates in a liquid containing basin in front of the conveying span of the belt conveyor;

(B) Positioning a defined hole pattern in the basin of a first conveyor belt adjacent to the front side of the stack;

(C) Moving the stack in direction of the first conveyor belt and in a suction position;

(D) Detecting the suction position of the substrate which is next to the first conveyor belt and separation of the substrate in the basin from the stack;

(E) Sucking the substrate in the basin by means of vacuum against the hole pattern of the first conveyor belt;

(F) Detecting the sucked substrate and triggering a conveyor sequence of the first conveyor belt;

(G) Moving the substrate by means of the conveyor belt out of the basin and slewing of the substrate with respect to the front side of the stack during conveying with the belt conveyor;

(H) Detaching and separating the object from the first conveying belt;

(I) Positioning of the defined hole pattern of the first conveyor belt with respect to the front side of the stack upon finishing the conveyor sequence of the conveying belt; and

(J) Repeating steps (C) to (I), until the stack is completely separated.

In an optimized variant of the method disclosed in DE 10 2006 011 870 B4, the vacuum device is activated just when the substrate which is most proximate to the conveying belt is detected in its suction position.

An advantageous further embodiment of the above described method envisages that the substrate which is sucked against the first conveying belt is transported away from the front side of the stack and to a second conveying belt which follows the first conveying belt, wherein the second conveying belt has, in respect of the first conveying belt, a smaller inclination angle, and the object is handed over to the second conveying belt for further transport.

According to another preferred process sequence, the vacuum device is deactivated upon handing over of the object to the second conveying belt.

Above, the characteristics of the technology as defined in DE 10 2006 011 870 B4 which had to be improved according to the invention have been explained. In respect of supplemental information as well as a detailed explanation of the process of separation, reference is made to the FIG. 1 as well as the subsequent description of this figure. By means of this technique, substrates which are provided in a stack can be separated relatively gentle and in an automated manner. However, disadvantageous is the constructive effort because of the usage of, in total, three conveying belts, as well as the risk of a damage of the conveyed substrate, caused by the guiding elements of the belt conveyor.

The object of the invention is therefore the provision of an improved apparatus and a method using this improved apparatus, by means of which an almost damage-free removal of thin, fragile and stacked substrates is enabled with a, by way of comparison, significantly lower instrumental effort.

In regard of the components which are required according to the invention as well as their mode of operation, explicit reference is made to the description regarding the state of the art according to DE 10 2006 011 870 B4. Therefore, only the differences according to the invention with regard to this state of the art are explained in the following.

The object is solved according to the invention by providing an improved apparatus as defined in claim 1, as well as a method using the improved apparatus as defined in claim 7.

Therefore, the present invention relates to an apparatus for the separating, deflecting and transporting of disc shaped substrates which are sequentially arranged standing one after another in feed direction in the form of a substrate stack within a liquid, comprising a vertical belt conveyor with at least two directly contiguously arranged conveyor belts, whose conveying span is arranged at one front side of the stack parallel to the front side, wherein the belt conveyor has a vacuum device by means of which the respective foremost substrate of the stack can be sucked against at least a first conveyor belt, and wherein the at least two conveyor belts of the vertical belt conveyor are arranged coplanar to each other in the adjoining region. According to the invention, the length of the second conveyor belts' region which is arranged coplanar to the first conveyor belt corresponds, in vertical conveying direction, to at least a third of the substrate length, wherein the second conveyor belt comprises two conveying legs subsequent to its coplanar region.

The most substantial difference with regard to the apparatus as defined in DE 10 2006 011 870 B4 is that all of the aforementioned guiding aids, such as in particular the support band with conveying belt which is arranged parallel to the suction band, can be omitted.

As described above, the DE 10 2006 011 870 B4 requires in the preferred embodiment of a vertical belt conveyor that the substrate is pressed against the conveying belt with a force that acts onto the substrate in order to achieve a sufficient friction force between the substrate and the conveying belt. For this, the usage of a support band or a support belt, being arranged parallel to the suction band or the conveying belt, is particularly proposed, so that the substrate can effectively be clamped and secured against a falling off contrary to the feed direction.

According to the invention, it surprisingly turned out that the substrate which is removed and which is fixed to the first conveying belt of the suction band by means of vacuum securely remains adhering to the belt conveyor also during the handing over to the transport band's second conveying belt which directly follows in removing direction, and that the substrate is protected from a falling off contrary to the feed direction. As aforesaid, the first conveying belt, as part of the suction band, is according to the invention preferably not charged with a vacuum in the region of at least 1 mbar, but with a weaker negative pressure, which amounts for example to a value between 0.3 and 0.5 bar and preferably approximately to 0.4 bar. These weak negative pressures enable a reduction of the forces that act upon the substrates and result in the formation of the desired adhesion force, wherein a fluid or liquid film is maintained between the surfaces of the substrates and the conveying belts.

Since the second conveying belt which is comprised by the transport and of the apparatus disclosed in DE 10 2006 011 870 B4 does, however, directly follows conveying belt of the suction band, but provides to the substrate surface in the vertical direction only an area which allows a line contact, thus being insufficient for the formation of an adhesion, the substrate can not be secured against a falling of contrary to the feed direction, which is why the proposed support band is mandatory. On the contrary, the at least two conveying belts of the vertical belt conveyor are, according to the invention, arranged coplanar to each other in the adjoining region, such that an area of the second conveying belt's vertical section can be provided to the substrate surface which is sufficient for maintaining the adhesion forces. As depicted in the FIGS. 1 and 2, simplified by means of omitting several components, the length of the second conveyor belts' region which is arranged coplanar to the first conveyor belt corresponds, in vertical conveying direction, to at least a third of the substrate length. The further guiding of the second conveyor belt which, according to the invention, fulfills, besides its vertical conveying function, also the function of the transport band as defined in DE 10 2006 011 870 B4, runs mostly as described in this document by provision of two legs 23 and 24, wherein the latter is substantially horizontally oriented.

For the support of the liquid effected adhesion, the second conveying belt is preferably humidified or wetted by a liquid, which for example can take place in that region of the continuous belt which can not serve as contact surface for the substrate due to its geometrical orientation. Particularly preferred, the wetting takes place in a (vertical) section following the leg 24 of the second conveying belt, such that already in the region of the second conveying belt that runs coplanar to the first conveying belt, an adhesion providing liquid film can be provided to a substrate. Most preferred, a wipe-off roll, being adjustable in terms of pressure by means of e.g. springs, acts upon the second conveying belt, the roll being arranged between wetting means and the vertical, coplanar region of the second conveying belt, which enables the precise dosing of the wetting liquid and therefore the precise adjustment of the liquid film which is desired for adhesion.

For a secure fixing of a substrate to be removed to the first conveying belt as part of the suction band, it is necessary to have an active low pressure that can be generated inside or outside of the apparatus by dynamic methods (e.g. a pump), static methods (low pressure vessel) or other methods. If eventually the first conveyor belt and substrate are in direct contact so that only a very thin fluid film (some nanometers up to 50 micrometers) is present between belt conveyor and substrate, adhesion forces build up in the close interspace that allow from now on for self-acting adherence or adhesion of the substrate to the conveying belt. Maintenance of the active low pressure is no longer necessary.

According to an alternative embodiment, the desired adhesion can also be effected by squeezing out the fluid from between the surfaces by approximation of the same, wherein the invention also envisages a combination of these embodiments.

These adhesion forces are particularly greater than those to the following substrate, so that the unloading of the substrate to be separated with the conveying belt can be effected parallel to the surface direction of the following substrate. In doing so, at the most only minor shear forces act onto the substrate to be separated, thereby considerably decreasing the breakage rate. Tensile or compressive forces are avoided. Given a surface contact that is large enough, the adhesion forces are greater than the forces being generated by the temporary low pressure. Unloading from the substrate stack with a high frequency is possible. Furthermore, the adhesion forces are of such a magnitude, that they, depending on the geometrical design of the conveying belt and the substrate weight, still allow for adhesion of the substrate to the belt conveyor even without generation of active low pressure, in particular when the substrate is located outside of the fluid surrounding the substrate stack.

According to a further embodiment, in particular the first conveying belt can be designed as a flexible band made from a suitable material such as e.g. plastic, wherein the band is most preferably designed in such a manner that its surface is passable for the fluid, so that the fluid both can be sucked and emitted as well as displaced. For this purpose, openings in the form of boreholes as well as in the form of a porous basic material can be provided.

According to the invention, the low pressure is generated at the beginning of the unloading phase. Even if this low pressure must only be maintained until the afore-mentioned fluid film between substrate and contact area of the first conveying belt is obtained, the low pressure may as well be maintained until the substrate is located on the substantially horizontal section of the second conveying belt.

According to a preferred embodiment, the belt conveyor according to the invention has a further vacuum device by means of which the second conveyor belt can be pressurized in the region of the conveyor leg 23 which follows the coplanar region. In this manner, the slewing or deflecting of the substrate with respect to the front side of the stack is supported, and a tilting away of substrate contrary to the transport direction is excluded, wherein the last-mentioned effect is already ensured to a wide extent by the inclination of the conveying span 23. According to this embodiment, the second conveying belt preferably has the same characteristics as the first conveyor belt.

The carrier device is designed in such a manner that it can take up at least one substrate stack consisting of a plurality of substrates or wafers, respectively. Further, the carrier device has means such as, in particular, lateral brush strips, by means of which it is ensured that the individual substrates are securely held in position, optionally until their respective removal. Preferably, the brush strips are arranged hingeable or slewable at the carrier device, thus being also just temporarily useable.

The carrier device is moveable in at least one direction. Preferably, it is moveable in feed direction; to be precise, firstly so far until the first substrate to be separated of the substrate stack arrives at the optionally present position detection device. Afterwards, it is e.g. moveable in steps, wherein the step width preferably corresponds to the respective substrate thickness that normally is constant over the stack; to be precise, so far until eventually the stack's last substrate is brought up to the unloading device. Alternatively, the carrier device can be designed stationary. In this case, suitable means would be provided with which the substrate stack can be moved in feed direction on the carrier device. Alternatively or additionally, the conveying belt as well as the optionally present position detection device may have greater degrees of freedom at their disposal, so that they are moveable opposite to the feed direction in direction of the stack start.

The preferably provided position detection device is a device for the detection of the position and location of the substrate to be separated. Alternatively, the usage of a sensor element, for example in the form of a touch sensor is possible, which emits a corresponding signal, therefore enabling the belt conveyor to separate and transport away the substrate to be separated.

According to a further aspect, according to the invention, a method is disclosed for the separating, deflecting and transporting of disc shaped substrates which are sequentially arranged standing one after another in feed direction in the form of a substrate stack within a liquid, with a vertical belt conveyor with at least two conveyor belts, whose conveying span is arranged at one front side of the stack parallel to the front side, wherein the belt conveyor has a vacuum device by means of which the respective foremost substrate of the stack can be sucked against at least a first conveyor belt, and wherein the at least two conveyor belts of the vertical belt conveyor are arranged coplanar to each other in the adjoining region, and the length of the second conveyor belts' region which is arranged coplanar to the first conveyor belt comprises two conveying legs 23, 24 subsequent to its coplanar region. The method comprises the following steps:

(A) Providing a substrate stack in a liquid containing basin in front of the conveying span of the belt conveyor;

(B) Positioning a defined hole pattern of a first conveyor belt adjacent to the front side of the stack;

(C) Moving the stack in direction of the first conveyor belt and in a suction position;

(D) Detecting the suction position of the substrate which is next to the first conveyor belt and separation of the substrate in the basin from the stack;

(E) Sucking the substrate in the basin by means of vacuum against the hole pattern of the first conveyor belt;

(F) Detecting the sucked substrate and triggering a conveyor sequence of the first conveyor belt;

(G) Moving the substrate by means of the conveyor belt out of the basin and handing over of the substrate to the second conveyor belt;

(H) Slewing the substrate with respect to the front side of the stack;

(I) Positioning of the defined hole pattern of the first conveyor belt with respect to the front side of the stack upon finishing the conveyor sequence of the conveying belt; and

(J) Repeating steps (C) to (I), until the stack is completely separated.

According to a preferred embodiment, the slewing of the substrate takes place as defined in step (H) on the surface of the conveying leg 23 which follows the coplanar region of the second conveying belt. It is further preferred that that the second conveyor belt is humidified or wetted in order to enhance the formation of an adhesion force regarding the substrate. Finally, the belt conveyor preferably has a further vacuum device by means of which the second conveyor belt can be pressurized in the region of the conveyor leg 23 which follows the coplanar region.

Further advantageous embodiments follow from the subsequent description, the claims as well as the figures.

### DRAWINGS

Depicted are in:

FIG. 1 a schematic representation of the apparatus according to the state of the art as disclosed in DE 10 2006 011 870 B4;

FIG. 2 a schematic representation of the apparatus according to the invention in a side view;

FIG. 3 a perspective representation of the embodiment as shown in FIG. 2.

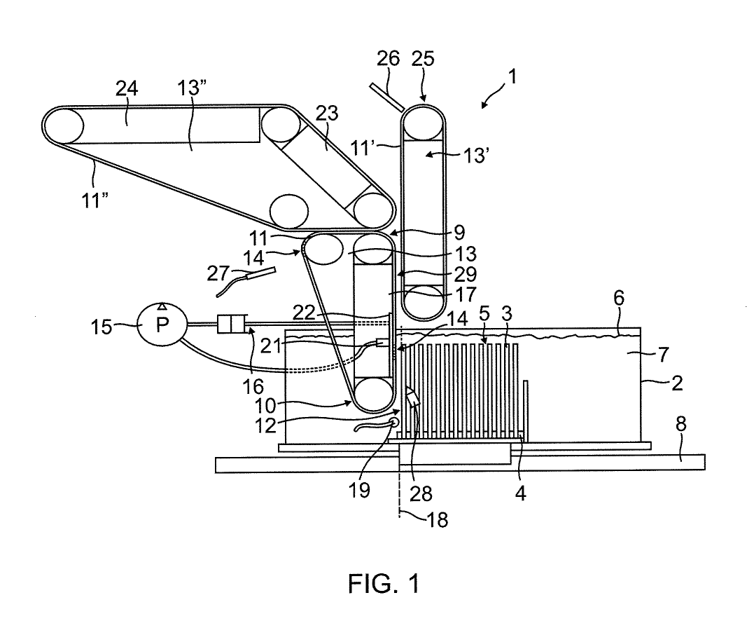

In FIG. 1, the apparatus according to the state of the art as disclosed in DE 10 2006 011 870 B4 is schematically represented. This apparatus is suitable for the separating and transporting of disc-shaped substrates.

The separation device 1 shows a basin 2, in which the plate shaped substrates 3 to be separated, for example silicon plates, are received standing in a carrier device 4, forming a standing stack 5, wherein the basin 2 is filled up to the upper edge 6 with a liquid 7. The basin 2 is mounted on a drive 8 which, by moving the basin 2, feeds the carrier device 4 to the belt conveyor 9 for separation and transporting. The liquid 7 is a cleaning liquid, the basin 2 is a cleaning bath.

The belt conveyor 9 has a conveying span 10, whose conveying belt is arranged opposite to a front side 12 of the stack 5 and parallel to the front side 12. The span 10 comprises, besides the conveying belt 11, two further conveying belts 11′ and 11″ which can be covered by a coating not shown in the drawing, such as sylomere, and which take over the silicon plates 3 from the conveying belt 11 and transport them further.

The conveying belt 11 which is part of a suction band 13 has a defined hole pattern 14, through which, by means of a pump 15 which is part of a vacuum device 16, the liquid 7 can be sucked via a suction plate 17 from the basin 2. A position sensor 19 is provided for detection of an initial position 18 of the silicon plate 3 which is positioned at the front side 12 of the stack 5, wherein the position sensor stops the drive 8 which is designed as a linear axis, and sucks the liquid through the conveying belt 11 of the suction band 13 via a suction valve. Thus, the foremost silicon plate of the stack 5 is sucked to the conveying belt 11 of the suction band 13.

A pressure switch 21 recognizes that the silicon plate 3 is sucked, and starts a transport sequence of the suction band 13. The pressure switch 21 is depicted in the suction plate 17. It can be connected by means of a T-piece (not depicted) to a vacuum device's 16 suction duct which leads to the suction plate 17. The silicon plate 3 is removed from the front side 12 of the stack 5 by means of the motion of the sucking conveying belt 11 to which the silicon plate adheres due to negative pressure. During turning of the conveying belt 11, the silicon plate 3 remains sucked against the conveying belt 11 of the suction belt 13 because of suction ducts 22 located in the suction plate 17, until the silicon plate 3 is transported upwards into a interspace 29 between the suction band 13 and the support band 13′ which are arranged parallel to each other.

Alternatively, the conveying belt 11 can be continuously driven. The drive is interrupted only when no silicon plate 3 is present in a pick up position on a hole pattern 14 of the conveying belt 11. This is detected by the pressure switch 21. As soon as a silicon plate 3 is present in front of the hole pattern 14, the conveying belt 11 is started again.

After the hole pattern 14 of the conveying belt 11 has removed itself from the region of the suction plate 17 which has the suction ducts 22, the silicon plate 3 is clamped between the support band 13′ and the suction band 11 and/or a transport band 13″ which follows the suction band 11, and transported upwards. The conveying belt 11′ of the support and 13′ and the conveying belt 11″ of the transport band 13″ have, according to the depicting embodiment, no hole pattern and no vacuum device.

The suction band 13 and the support band 13′ are vertically running linear bands which are arranged offset in a small distance to each other. Between themselves, they form the interspace 29. The transport band 13″ which takes over the silicon plate 3 from the suction band 13 is designed kinked. The transport bands' 13″ leg 23 which adjoins the suction band 13 has a typical inclination of 45°, while the free leg 24 is arranged horizontally. Thus, the silicon plate 3 which is received standing in the carrier device 4 is slewed during the separation process by an angle of 90° around its transverse axis, and provided in a lying position at the end of the conveying span 10 of the belt conveyor 9. If the angle of 45° is not sufficient for a secure transport of the silicon plates 3, the angle between the transport band 13″ and an imaginary horizontal can be reduced to for example 30°. Then, the silicon plates 3 are slewed at first by 60° and subsequently by 30°, instead of 45° twice, in total by 90° from the originally vertical into the horizontal position, and then transported.

The conveying belts 11, 11″ can have a common drive. If they have respective individual drives, the separated silicon plates 3 can be “drawn apart”, i.e. their distance grows (or shrinks), by means of different belt velocities, or by stopping one of both conveying belts 11, 11″ while the other conveying belt 11″, 11 continues.

A deflector 26 is arranged at the upper end 25 of the support band 13′, which forms, together with the support band 13′, the guiding elements 13′, 26 of the belt conveyor 9, these guiding elements acting upon the silicon plate 3 after the same is not held any more by means of negative pressure at the conveying belt 11 of the suction band 13. Upon touching the deflector 26, the silicon plate 3 tilts onto the inclined leg 23 of the transport band 13″ which moves the silicon plate 3 further, until the plate tilts at the end of the inclined leg 23 because of gravity onto the horizontal leg 24 of the transport band 13″. Instead of the depicted deflector 26, one or several brush strips can be arranged in the region of the upper end of the support band 13′ (not depicted) as deflectors for the secure detachment of the silicon plates 3 from the support band 13′, and for the tilting onto of the transport band 13″.

The suction band 13 has a paced drive which is not shown in the drawing, which can directly or indirectly drive also the transport band 13″ as well as the support band 13′. Thus, it is possible to for example act by means of the suction band's 13 conveying belt 11, using frictional contact, upon the conveying belt 11″ of the transport band 13″, such that in turn, the conveying belt 11″ can drive via the clamped silicon plate the conveying belt 11′ of the support band 13′.

The position of the whole pattern 14 of the conveying belt 11 is detected by means of a hole pattern sensor 27, wherein the hole pattern 14 is present twice in the depicted embodiment. Accordingly, the conveying sequence of the suction band 13 corresponds to a semi-rotation of the conveying belt 11. The whole pattern sensor 27 is arranged on a return side of the suction band 13 and stops the conveying belt 11 as soon as a hole pattern 14 is positioned above the suction ducts 22 adjacent to the front side 12 of the stack 5. The conveying belt 11 remains in this position until a silicon plate 3 has approached the conveying span 10 so close that it is recognized in the initial position 18 by the position sensor 19 which controls a vacuum device 16, and until a silicon plate 3 has been sucked by the vacuum device 16.

In of the to facilitate the separation of the foremost silicon plate 3 from the stack 5, liquid 7 is injected by means of a nozzle 28, and by a pump which is not depicted in the drawing, from the basin 2 in between the silicon plates 3 which are most proximate to the hole pattern 14, such that these plates are separated.

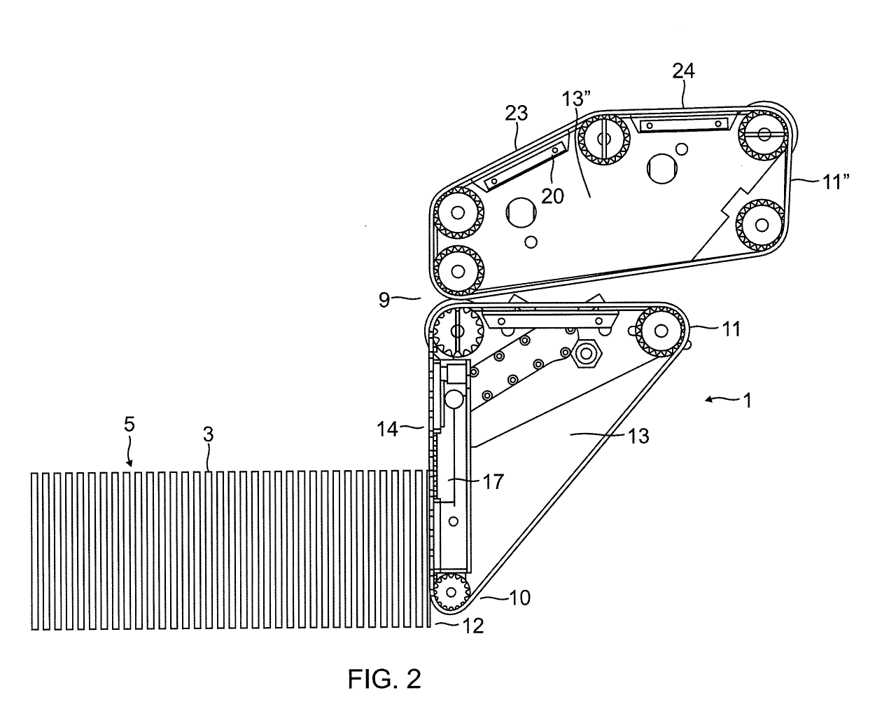

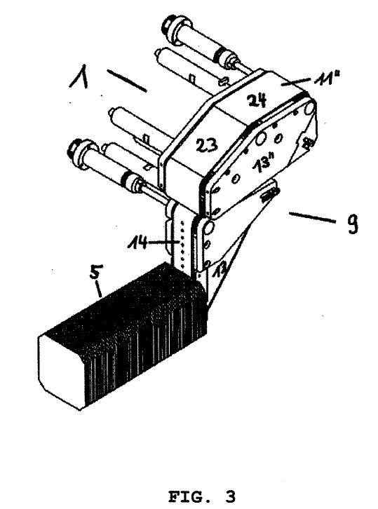

In FIGS. 2 and 3, a preferred embodiment of the apparatus 1, being further developed according to the invention, for the separation of a substrate stack 5 is depicted. In this exemplary embodiment, the substrates 3 are arranged in a substrate stack 5, wherein the substrate stack 5 rests in a carrier device (not depicted). The individual substrates 3 are already detached from a holding device. When the apparatus 1 is arranged within a fluid, it is possible that the individual substrates 3 float or leave the carrier device unintentionally, which is why the carrier device preferably has two lateral brush strips that run parallel to each other in transport direction, which temporarily laterally support the substrates within the standing stack, e.g. during the transport of the carrier device to the separation device until their respective removal. Particularly preferred, the brush strips are arranged detachable or hingeable at the carrier device. Alternatively or additionally, the substrates, and thus, the substrate stack, can be positioned slightly inclined against the feed or transport direction within the carrier device.

The individual planar-shaped substrates 3 are arranged next to each other in such a way that their surfaces contact each other. Adhesion forces act between them that result from the very small interspace between the substrates and from possible contaminations e.g. from a preceding sawing step. Due to this arrangement the substrates 3 determine a defined feed direction.

Further, according to the invention, a belt conveyor 9 with a conveying span 10 as well as to conveying belts 11 and 11″ provided, which form one respective part of the suction band 13, or the transport band 13″, respectively. The at least one hole pattern of the suction, band 13 is depicted in FIG. 3 and corresponds, to the greatest possible extent, to the above description regarding FIG. 1. Continuing the vertical course of the conveying belt 11, the conveying belt 11″ links itself to this conveying belt 11, wherein the vertically running section of the conveying belt 11″ preferably corresponds to at least a third of the substrate length in conveying direction. The conveying belt 11″ runs subsequent to this vertical section in an inclined manner, such as e.g. at an angle of 45°, before it is horizontally guided in a third section. The preferably provided vacuum device 20 is located below the second conveying belt 11″ in the second section of the conveying leg 23.

It is preferred that at least certain parts of the apparatus 1, namely the carrier device, the substrate stack 5, as well as parts of the belt conveyor 9 are arranged within a fluid. Therefore, the substrates do not fall dry during the entire procedure; at least, until their complete separation.

The present invention was explained in regard of the treatment of silicon wafers. As a matter of course, disc shaped substrates made from other materials such as plastics can also be treated according to the invention.

### LIST OF REFERENCES

1 apparatus
2 basin
3 substrate, silicon plate
4 carrying device
5 substrate stack, stack
6 upper edge
7 liquid
8 drive
9 belt conveyor
10 conveying span
11 first conveyor belt (as part of the suction band 13)
11′ conveyor belt (as part of the support band 13′)
11″ second conveyor belt (as part of the transport band)
12 front side of the stack
13 suction band
13′ support band
13″ transport band
14 hole pattern
15 pump
16 vacuum device
17 suction plate
18 initial position
19 position sensor
20 further vacuum device
21 pressure switch
22 intake ducts
23 inclined leg of the transport band 13′
24 horizontal leg of the transport band 13′
25 upper end of the support band 13′
26 deflector
27 hole pattern sensor
28 separating means
29 interspace

1. An apparatus (1) for the separating, deflecting and transporting of disc shaped substrates (3) which are sequentially arranged standing one after another in feed direction in the form of a substrate stack (5) within a liquid, comprising a vertical belt conveyor (9) with at least two conveyor belts (11, 11″), whose conveying span (10) is arranged at one front side (12) of the stack (5) parallel to the front side (12), wherein the belt conveyor (9) has a vacuum device (16) by means of which the respective foremost substrate (3) of the stack (5) can be sucked against at least a first conveyor belt (11), wherein the at least two conveyor belts (11, 11″) of the vertical belt conveyor (9) are arranged coplanar to each other in the adjoining region, and wherein the length of the second conveyor belts' (11″) region which is arranged coplanar to the first conveyor belt (11) corresponds, in vertical conveying direction, to at least a third of the substrate length, characterized in that the second conveyor belt (11″) comprises two conveying legs (23, 24) subsequent to its coplanar region.

2. The apparatus according to claim 1, characterized in that the belt conveyor (9) has a further vacuum device (20) by means of which the second conveyor belt (11″) can be pressurized in the region of the conveyor leg (23) which follows the coplanar region.

3. The apparatus according to claim 1, characterized in that it further comprises separation means (28) for the fanning of at least a part of the substrate stack (5).

4. The apparatus according to claim 1, further comprising a carrier device (4) which is moveable into at least one direction.

5. The apparatus according to claim 4, characterized in that the carrier device (4) has two brush strips which are laterally arranged parallel to each other.

6. The apparatus according to claim 5, characterized in that the brush strips are arranged foldable or slewable.

7. A method for the separating, deflecting and transporting of disc shaped substrates (3) which are sequentially arranged standing one after another in feed direction in the form of a substrate stack (5) within a liquid, with a vertical belt conveyor (9) with at least two conveyor belts (11, 11″), whose conveying span (10) is arranged at one front side (12) of the stack (5) parallel to the front side (12), wherein the belt conveyor (9) has a vacuum device (16) by means of which the respective foremost substrate (3) of the stack (5) can be sucked against at least a first conveyor belt (11), and wherein the at least two conveyor belts (11, 11″) of the vertical belt conveyor (9) are arranged coplanar to each other in the adjoining region, and the length of the second conveyor belts' (11″) region which is arranged coplanar to the first conveyor belt (11) corresponds, in vertical conveying direction, to at least a third of the substrate length, wherein the second conveyor belt (11″) comprises two conveying legs (23, 24) subsequent to its coplanar region, comprising the following steps:
(A) providing a substrate stack (5) in a liquid containing basin in front of the conveying span (10) of the belt conveyor (9);
(B) positioning a defined hole pattern (14) of a first conveyor belt (11) adjacent to the front side (12) of the stack (5);
(C) moving the stack (5) in direction of the first conveyor belt (11) and in a suction position;
(D) detecting the suction position of the substrate (3) which is next to the first conveyor belt (11) and separation of the substrate in the basin from the stack (5);
(E) sucking the substrate (3) in the basin by means of vacuum against the hole pattern (14) of the first conveyor belt (11);
(F) detecting the sucked substrate (3) and triggering a conveyor sequence of the first conveyor belt (11);
(G) moving the substrate (3) by means of the conveyor belt (11) out of the basin and handing over of the substrate to the second conveyor belt (11″);
(H) slewing the substrate (3) with respect to the front side (12) of the stack (5);
(I) positioning of the defined hole pattern (14) of the first conveyor belt (11) with respect to the front side (12) of the stack (5) upon finishing the conveyor sequence of the conveying belt; and
(J) repeating steps (C) to (I), until the stack is completely separated.

8. The method according to claim 7, characterized in that the slewing of the substrate according to step (H) takes place on the surface of the conveyor leg (23) which follows the coplanar region of the second conveyor belt (11″).

9. The method according to claim 8, characterized in that the second conveyor belt (11″) is humidified in order to enhance the formation of an adhesion force in regard of the substrate.

10. The method according to claim 7, characterized in that the belt conveyor (9) has a further vacuum device (20) by means of which the second conveyor belt (11″) can be pressurized in the region of the conveyor leg (23) which follows the coplanar region.
